(19) United States
(12) Patent Application Publication
(10) Pub. No.: US 2011/0054776 A1
(43) Pub. Date: Mar. 3, 2011

(54) LOCATION-BASED WEATHER UPDATE SYSTEM, METHOD, AND DEVICE

(75) Inventors: Plamen V. PETROV, Omaha, NE (US); James Maury, Colorado Springs, CO (US); Hasani Hunter, Omaha, NE (US)

(73) Assignee: 21st CENTURY SYSTEMS, INC., Omaha, NE (US)

(21) Appl. No.: 12/718,837

(22) Filed: Mar. 5, 2010

Related U.S. Application Data
(60) Provisional application No. 61/239,724, filed on Sep. 3, 2009.

(51) Int. Cl. G06F 15/16; G01C 21/00; G01S 3/02; G06F 3/048

(52) U.S. Cl. 701/201; 709/217; 715/702; 715/810; 715/764; 342/450

(57) ABSTRACT

A weather update system, method, and device for providing and receiving weather data. The mobile computing device includes a processor and a location data receiver capable of establishing a geospatial location of the mobile computing device based on received data signals. The mobile computing device is configured to receive updated weather data in response to a threshold condition having been, met, such as a threshold distance having been traveled by the mobile computing device or a threshold time having elapsed. The mobile computing device is also configured to receive weather alerts. The system includes a weather data server network configured to receive current and forecasted weather data for a plurality of locations and times, stored in a high-resolution grid structure and including current locations of a user devices or favorite locations for users. The weather data server network is configured to transmit weather data for the geospatial location of a mobile computing in response to a threshold condition having been met. The system also has an interactive map configured to enable a user to select a location for which the user would like to receive weather data and to store such locations as favorites.

### CROSS REFERENCE TO RELATED APPLICATIONS

This application claims priority and benefit under 35 U.S.C. §119(e) to U.S. Provisional Patent Application No. 61/239,724, entitled “Location-Based Weather Update System, Method, and Device”, filed on Sep. 3, 2009. The content of that application is incorporated herein in its entirety by reference.

### FIELD OF THE INVENTION

The present invention relates to a system, method, and device for providing location-based weather forecasts.

### BACKGROUND OF THE INVENTION

Some weather forecasts are disseminated through publications or TV or radio broadcasts. Because the broadcasts address a large audience, the forecasts often generalize the weather data for a large area or provide specific weather data for a few major locations within that area. Therefore, audience members, especially those who lived outside those major locations, receive forecasts that do not correspond to their exact location. This becomes a problem when the user wishes to track changing weather conditions, while on the move from one area to another, or within an area large enough to encompass dramatically changing weather conditions.

With the increasing use of the Internet, users have been able to receive more localized forecasts by sending requests to a weather data provider for weather data specific to a certain area, such as, for example, a zip code area. It should be noted that, for some users, located outside major metropolitan areas, a zip code area is large enough such that the aggregate forecast they would receive for that area is not accurate enough for their specific location. Users have to manually input their location, such as a zip code area, to request weather data from the weather data provider: As use of mobile computing devices, such as smart phones, have increased, users have been able to send and request information over the Internet, cellular networks, or other networks while travelling. This capability has allowed users to manually request weather data using their mobile devices. For example, users may input their location information, such as their city or zip code, into the device, which transmits a request for weather data for that geographical area. After a server receives and processes the request, the desired data is transmitted to the mobile device. However, to request weather data, users typically have to manually input their location. Thus, every time users travel to a new location with their mobile device, the users must manually input their location to receive weather data for that new location.

As such, there is a need for an easy to use, flexible, and efficient system, device, and method that automatically provides accurate location-based weather forecasts to the user based on the location of the device, the device being either stationary or moving.

### SUMMARY OF THE INVENTION

One aspect provides a mobile computing device for updating weather data. The mobile computing device includes a processor and a location data receiver capable of establishing a geospatial location of the mobile computing device based on received data signals. The mobile computing device is configured to receive updated weather data in response to a threshold condition having been met.

Another aspect provides a mobile computing device for updating weather data. The mobile computing device includes a housing, a location data receiver within the housing, and a processor within the housing. The mobile computing device further includes a user interface, the user interface allowing users to input a location on an interactive map, wherein said mobile computing device submits a request, which may be an automatic request, for weather data based on said input location.

Another aspect provides a system for updating weather data. The system includes a weather data server network configured to receive current and forecasted weather data for a plurality of locations and times. The weather data server network is configured to transmit weather data for the geospatial location of a mobile computing in response to a threshold condition having been met.

Another aspect provides a method for updating weather data. The method includes determining on a mobile computing device the geospatial location of said mobile computing device based on received data signals and receiving updated weather data in response to a threshold condition having been met.

Another aspect provides a method for updating weather data including presenting on a mobile computing device a user interface having an interactive map. The interface allows users to input a location on said interactive map. The method further includes the step of submitting a request, which may be an automatic request, for weather data based on the inputted location.

Another aspect provides a method for updating weather data including receiving at a data server network current and forecasted weather data for a plurality of locations and times. The method further provides the step of transmitting weather data for the geospatial location of a mobile computing device in response to a threshold condition having been met.

Another aspect provides a system for weather data delivery including a weather data server network arranged to receive weather data. The system further includes a mobile computing device comprising a location data receiver and a processor. The mobile computing device is capable of receiving geospatial data and establishing its geospatial location based on the data. The weather data server network transmits updated weather data for the geospatial location of the mobile computing device in response to a threshold condition having been met.

Another aspect provides a method for weather data delivery including receiving, at a weather data server network, weather data. The method further includes the step of determining the geospatial location of a mobile computing device based on geospatial data received by a location data receiver on the mobile computing device. The method also includes the step of transmitting from the weather data server network to the mobile computing device updated weather data for the geospatial location of the mobile computing device in response to a threshold condition having been met.

Another aspect provides a computer-readable medium having computer-executable instructions for execution by a processing system. The computer-executable instructions are for receiving weather data by a mobile computing device. The computer-readable medium includes instructions for determining a geospatial location of the mobile computing device based on received data signals. The instructions are also for calculating the distance traveled by the mobile device and the time elapsed since the last update or since the start of execution. The instructions are also for receiving updated weather data in response to a threshold condition having been met.

Another aspect provides a computer-readable medium having computer-executable instructions for execution by a processing system. The computer-executable instructions is for providing weather data by a weather data server network. The computer-readable medium comprising instructions for receiving current and forecasted weather data for a plurality of locations and times. The instructions are also for determining a geospatial location of a mobile computing device based on geospatial data received from the mobile computing device. The instructions are also for calculating the distance traveled by the mobile device and the time elapsed since the last update or since the start of execution. The instructions are also for transmitting weather data for the geospatial location of a mobile computing device in response to a threshold condition having been met.

These and other aspects of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment, the structural components illustrated herein can be considered drawn to scale. It is to be expressly understood, however, that the drawings are for the purpose of illustration and description only and are not a limitation of the invention. In addition, it should be appreciated that structural features shown or described in any one embodiment herein can be used in other embodiments as well. As used in the specification and in the claims, the singular form of “a”, “an”, and “the” include plural referents unless the context clearly dictates otherwise.

### BRIEF DESCRIPTION OF THE DRAWINGS

FIG. 1 is a block diagram of a location-based weather update system in accordance with an embodiment of the invention;

FIG. 2 is a block diagram of the modules of a location-based weather update device in accordance with an embodiment of the invention;

FIG. 3 is a flowchart illustrating the method of operation of the location-based weather update device in accordance with an embodiment of the invention;

FIG. 4 is a flowchart illustrating the method of operation of an interactive map feature of the location-based weather update device in accordance with an embodiment of the invention; and

FIGS. 5-12 illustrate a user interface and the interactive map feature of the location-based weather update device in accordance with one embodiment of the invention.

### DETAILED DESCRIPTION OF THE INVENTION

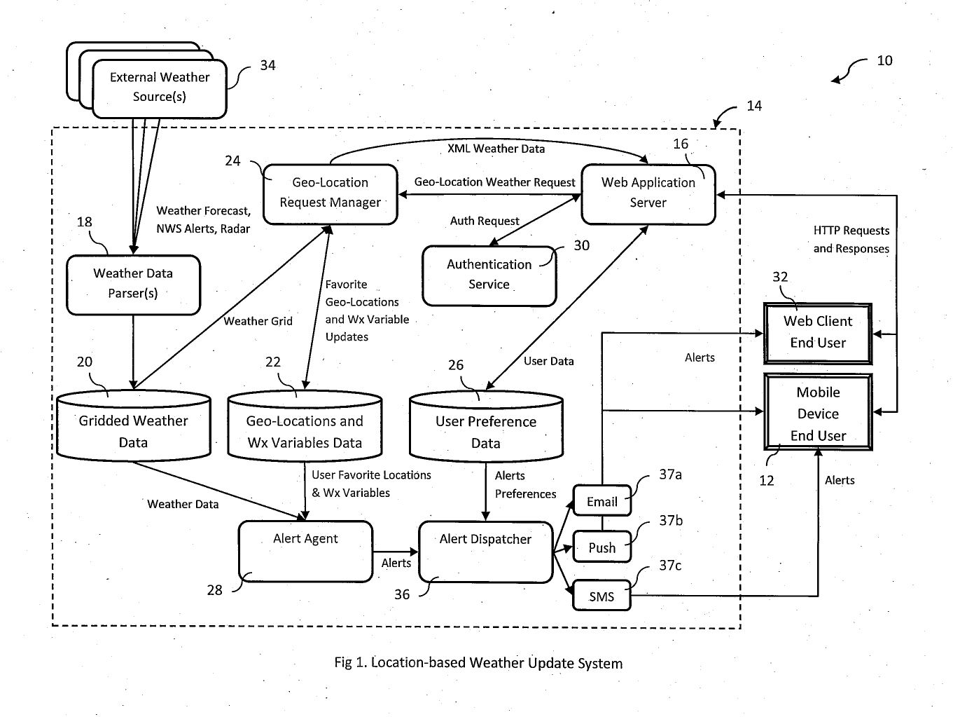

FIG. 1 shows a location-based weather update system 10 in accordance with an embodiment of the invention. The weather update system 10 includes a weather data server network 14 configured to receive current and forecasted weather data for a plurality of locations and times. A mobile computing device 12 is configured to determine its current location and may request current and forecasted weather data for its current location from the weather data server network 14 (thus defining a “find-me” feature). The weather data server network 14 is configured to transmit weather data for a geospatial location of the mobile computing device 12 in response to a threshold condition having been satisfied or met (thus defining a “track-me” feature). The threshold condition may comprise a threshold distance having been traveled by the mobile computing device 12 and/or a threshold time having elapsed, such as, for example, since the last update. The threshold distance and threshold time will be described in more detail later. The weather data may be data associated with the weather or weather forecasts over certain areas and over a period of time, and may include one or more weather variables. The weather data may also include a digital representation of certain weather variables over a period of time. The weather data may include current weather and/or forecasted weather information. The weather variables may be a data variable that represents certain measurable or predicted weather properties or characteristic, such as temperatures, wind speed, humidity, barometric pressure, chance of precipitation, amount of precipitation, or other properties. The geospatial location (or “geo-location”) may be a location on the Earth's surface or above the surface as depicted on a map or on a map display represented in some geospatial coordinate system (e.g. latitude/longitude, UTM, or others). A Latitude/Longitude geospatial coordinate system is used in a preferred embodiment.

As shown in FIG. 1, the weather data server network 14 may include a web application server 16, a weather data parser 18, a gridded weather database 20, a geo-locations and weather variables database 22, a geo-location request manager 24, a user preference database 26, an alert agent 28, and an authentication service 30. The web application server 16, which may serve as a router or hub to the other components of the weather data server network 14, may be configured to receive requests from the mobile computing device 12. The web application server 16 may relay the requests to the geo-location request manager 24, which may be configured to extract the relevant information from the gridded weather database 20 and send the information to the mobile computing device 12 through the web application server 16. The geo-location request manager 24 will be described in detail later. The various components of the weather data server network 14 may operate on software operating systems such as Windows, Linux, Solaris, Mac OS, UNIX, and/or others. In some embodiments, the gridded weather database 20, the geo-locations and weather variables database 22, and user preference database 26 may be based on relational databases, such as, for example, MySQL, Microsoft SQL Server, or Oracle. It is also contemplated that the number of the components of the weather update system 10 may vary. For example, in some embodiments, there may be a plurality of gridded weather databases 20. It is also contemplated that the components of the weather update system 10 may be run on one or multiple processors. The components shown in FIG. 1 can be implemented with any combination of hardware or software, including software executed by multiple computer systems or servers.

The mobile computing device 12 may be a cellular telephone, a smart phone, a pager, a personal digital assistant (PDA), a portable computer, or any other electronic device capable of receiving weather information. The mobile computing device 12 may include a system or device, such as a global positioning system, for tracking the location of the mobile computing device 12. The mobile computing device 12 may also include a timer subsystem or device and a user interface, such as one or a combination of a touch screen, screen, and/or a mouse pointer. Details of the mobile computing device 12 will be explained, later. It is also contemplated that the weather data service network 14 may be associated with a web client 32 through a device, such as a personal computer, or any other electronic device capable of receiving weather information. Thus, some of the descriptions herein with respect to the mobile computing device 12 may be applicable to the web client 32. The mobile computing device 12 or the web client 32 may be configured to submit requests and receive weather updates to and from the web application server 16 via a mobile phone network, the Internet, a mobile phone network with wireless application protocol (WAP), a local area network (LAN), a wide area network (WAN), a wireless local area network (WLAN, also known as WiFi network or IEEE 802.11x network), a facsimile network, a satellite network, RF network, or other communication means. The requests may be triggered manually, such as, for example, by a user pushing a button to request weather updates, or automatically, the details of which will be described later.

The mobile computing device 12 or web client 32 may send requests to the weather data server network 14 for updated weather data. The request may include at least one geo-location and zero or more weather data variables. The request is initially sent to the web application server 16, which is configured to process the request. Communication between the web application server 16 and the mobile computing device 12 or the web client 32 may be made according to the HyperText Transfer Protocol (HTTP). The web application server 16 may be configured to perform authentication of the mobile computing device 12 or web client 32 through the authentication service 30. Details of this process will be described later.

The weather data server network 14 may be configured to receive weather data, including forecasted weather data, from one or a combination of external weather sources or vendors 34, such as, for example, the National Weather Service (NWS), the National Center for Atmospheric Research (NCAR), and/or others. The weather data parser 18 may be configured to receive the forecasted weather data and parse the forecasted weather data. The weather data parser 18 may parse the data using software, rules, and/or logic. After the weather data parser 18 has parsed the data, the forecasted weather data may be stored in the gridded weather database 20 as a gridded weather data model. For example, in one embodiment, weather data may be included on a grid, wherein the distance between adjacent points on the grid are 1 km or less. Forecasted weather information may be provided to the weather data server network 14 from the external weather sources 34 at frequent intervals (1 hour, 30 minutes, 15 minutes, etc.). The forecasted weather information may be provided automatically or may be requested by the weather data server network 14 at constant or various intervals.

An end-user, via a web client 32 or a mobile computing device 12, may receive personalized weather data or alerts based on user preferences, such as the user's favorite locations and one or more weather variable (“favorite variables”). The favorite locations may be locations that the user has selected to be stored on the mobile computing device 12 and/or the data server network 14. The favorite locations may be associated with, for example, the user's home, office, children's school, and/or other locations for which the user would like weather data. The favorite location may be associated with additional data, such as a location nickname, a user's name, user's address, or an activity. The one or more weather variable preferences, or favorite variables, may be a collection of weather variables that a user has selected to be received on the mobile computing device 12 and/or stored on the weather data server network 14. One or more user-defined favorite locations and/or one or more weather variables for which to retrieve weather data values may be specified by the user. As described above, the weather variables may be a certain measurable or predicted weather property or characteristic, such as temperatures, wind speed, humidity, barometric pressure, amount of precipitation, or amount of precipitation, or others. The geo-locations and weather variables database 22 may be configured to store information associated with the user's current location, the user's favorite locations and favorite variables. In one embodiment, the geo-locations and weather variables database 22 may store the user's favorite locations and favorite weather variable settings. In another embodiment, the geo-locations and weather variables database 22 may optionally store the user's favorite locations and the values of the favorite weather variables associated with the favorite locations. As such, the geo-locations and weather variables database 22 may be configured to retrieve the value of the weather variables from the gridded weather database 20. The weather variables database 22 may also store one or more conditions for each weather variable, based on user-defined alert thresholds. For example, a particular user may set a threshold level of 95 degrees Fahrenheit for a certain location, such as the user's home. The weather variables database 22 may then store a weather variable for temperature, such as the temperature associated with the user's home location, and a condition for that variable, such as temperature >95 degrees Fahrenheit. If the temperature forecast for that location exceeds 95 degrees Fahrenheit at some point in the future, an alert may be issued to the mobile computing device 12 for that user.

The user preference database 26 may be configured to store user preferences and authentication information, such as the user names, passwords, and other information. In one embodiment, the user preferences database 26 may also store the favorite variables and favorite locations. In one embodiment, the user preferences database 26 may also store the alert preferences. The alert preferences may include one or more weather variable alert delivery preferences such that alerts will be issued to the mobile computing device 12 via the appropriate alert delivery mechanism, such as e-mail 37a, push 37b, or text message/SMS 37c once a condition (or thresholds) has been satisfied.

As described above, the web application server 16 performs authentication of the mobile computing device 12 through the authentication service 30. Each request from the mobile computing device 12 comprises an identification information for the mobile computing device, such as a user name and password. The user may optionally save the user name and password on the mobile computing device 12 or may manually input the information. In one embodiment, the web application server 16 authenticates the identification information using the information stored in the user preference database 26. The authentication service 30 may optionally use digital certificate-based authentication (such as, for example, TLS, SSL, or others). Once the mobile computing device 12 has been authenticated, the web application server may then relay the request to the geo-location request manager 24. The geo-location request manager 24 will be described in more detail later.

The alert agent 28 may be associated with a processor configured to perform continuous background processing. The alert agent 28 may be configured to continuously correlate geo-locations, the weather data for those locations, and weather variable conditions, such as the thresholds mentioned above. The alert agent 28 may continuously access information stored in the geo-locations and weather variables database 22 and may extract values of weather variables or other information from the gridded weather data. For example, in one embodiment, the alert agent 28 may continuously monitor the values of the user's favorite variables for the user's favorite locations in the gridded weather database 20 based on the user's favorite locations and user's favorite variables and conditions stored in the geo-locations and weather variables database 22. When a user-specified weather variable condition (such as temperature >95 degrees Fahrenheit, or Wind Speed >15 mph) is satisfied for a location of interest based on the current or forecast weather data, the alert agent 28 generates an alert for that condition and sends the alert to the alert dispatcher 36. The alert dispatcher 36 may be configured to send the alert to the mobile computing device 12 based on the user preferences for alert delivery stored in the user preference database 26. The alert dispatcher 36 may be configured to invoke the appropriate alert dispatch method, such as for example, SMS alert 37c, email alert 37a, or push alert 37b, so that the end-user device may receive the alert via one of those methods. Some of the methods, such as the SMS, for example, may be limited to only a subset of the mobile computing devices 12, such as mobile phones. In one embodiment, the push alert may be a WAP Push message that displays an alert message to the user. A push function comprises automatically routing messages, alerts, and other data to the mobile computing device 12 without requiring a request from the mobile computing device 12.

As mentioned previously, the geo-location request manager 24 may be a processor configured to receive requests from the mobile computing device 12 via the web application server 16. After the geo-location request manager 24 has received the request, the geo-location request manager 24 may process the request for weather data at the specified location. This may include extracting the requested weather data and weather variables from the gridded weather database 20 for the current location of the mobile computing device 12 and/or the favorite locations (as stored in the geo-locations and weather variables database 22). Multiple variables or multiple time slices of one or more variables may be requested. The geo-locations request manager 16 may be configured to process the weather data it receives from gridded weather database 20 so that the geo-locations request manager 16 may send the processed weather data to the mobile computing device 12 as a response to the original request. In one embodiment, the geo-locations request manager 16 may send the weather data in XML format through the web application server 16 to the mobile computing device 12.

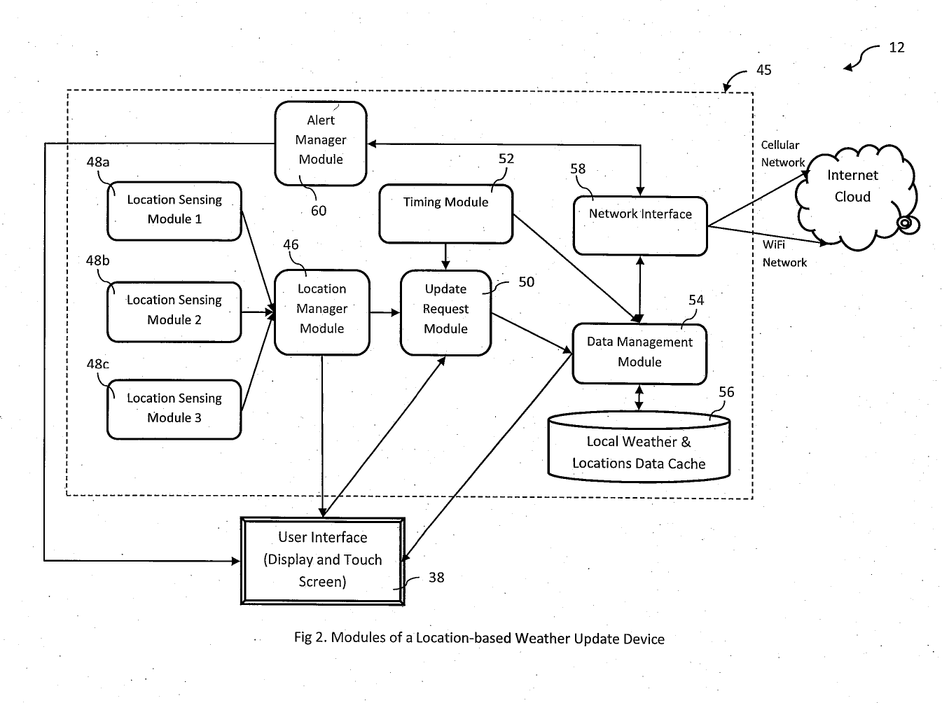

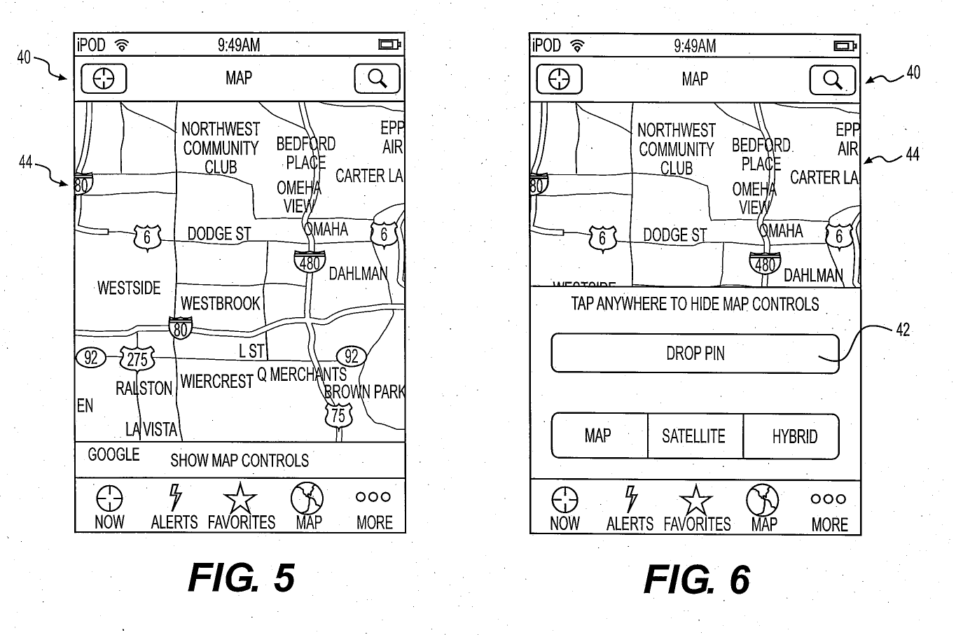

The mobile computing device 12 may be carried by the user or mounted in a vehicle. The mobile device 12 may have a portable power supply, or it may require connection to a power grid. The mobile device 12 may include one or multiple processors and memory. In one embodiment, the mobile computing device 12 provides a graphical user interface 38 (see FIG. 2). The user interface 38 may include a display 40 (see FIG. 5) and an input device, such as a touch screen (see FIG. 6), a mouse pointer, a keyboard, or other devices. The input device may be integral with the display 40 or may be separate and configured to interact with the display. The user interface 38 may provide an interactive map 44 (see FIG. 5) that allows users to select one or more locations on the map 44. The user interface 38 may be configured to display weather data automatically, or may display updated weather data based upon the user's request.

As shown in FIG. 2, the mobile computing device 12 may include the user interface 38 and a mobile device application 45. The mobile device application 45 may include a location manager module 46, location sensing modules 48a, 48b, 48c, an update request module 50, a timing module 52, a data management module 54, a local weather and locations data cache 56, a network interface 58, and an alert manager module 60. It is contemplated that in some embodiments, the configuration and components of the mobile device application 45 may vary. For example, there may be multiple caches 56 or only one location sensing module 48a, 48b, or 48c. The location manager module 46 may be configured to provide the current location of the mobile computing device 12. The location manager module 46 may be operatively connected to one or more of the location sensing modules 48a, 48b, and 48c. The number of location sensing modules 48a, 48b, and 48c may vary in some embodiments. The location sensing module 48a, 48b, and/or 48c may be associated with global positioning system devices integral or separate from the mobile computing device 12. The global positioning system is a system of satellites that transmit radio frequency signals that allows a receiver device to calculate its geospatial location based on the signals. Alternatively, the location of the mobile computing device 12 may be provided by WiFi or cellular signals and the location sensing modules 48a, 48b, and/or 48c may be associated with receivers capable of receiving those signals. For WiFi or cellular signals, the calculation may also use a source-based map that relates the signal source to the location of that source. The calculation may be performed through hardware, firmware, or software on the mobile computing device 12. Signal triangulation and source geo-coding may be used by the mobile computing device 12 to compute the mobile computing device's 12 physical location and motion, such as speed and direction of movement. The location of the mobile computing device 12 may optionally be provided by radar technology, the Internet, transponder technology, triangulation of multiple cellular towers, or other any other type of technology capable of tracking the location of the mobile computing device 12. It is also contemplated that the components of the mobile computing device 12 may be run on one or multiple processors. The components shown in FIG. 2 can be implemented with any combination of hardware or software.

In one embodiment, the mobile device application 45 may request the user's permission before the mobile device application 45 can track the location of the mobile computing device 12 using any of the aforementioned locating technology. In one embodiment, the user's permission is requested each time the user accesses the mobile device application 45 through the interface 38. Alternatively, the user's permission may be requested only once, such as the first time that the user accesses the mobile device application 45 through the interface 38.

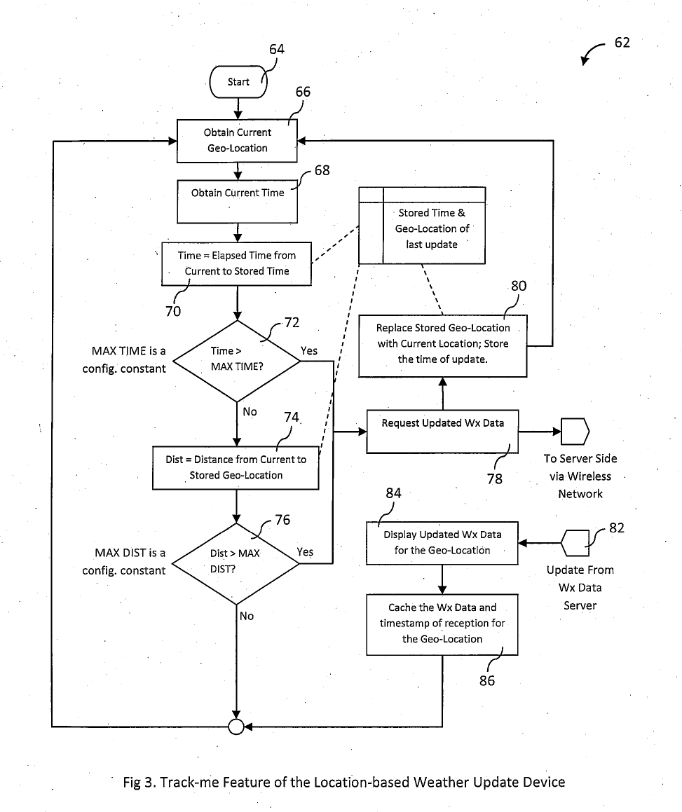

The update request module 50 may be configured to determine whether an update request should be sent to the weather data server network 14. The update request module 50 determines this information by receiving the current location of the mobile computing device 12 from the location manager module 46 and applying the algorithm or method of operation of FIG. 3, which will be described later. The local weather and locations data cache 56 may be configured to store the weather data that the mobile computing device 12 receives from the weather data server network 14. The data management module 54 may be configured to access the information stored in the local weather and locations data cache 56 and to display the information via the user interface 38. The local weather and locations data cache 56 may be associated with the mobile device's own memory or may be associated with a separate memory that may be accessed by the data management module 54. To determine whether an update is required, the update request module 46 may query the data management module 54 to determine if the weather data stored in the local weather and locations data cache 56 is based on the current location and/or time. If the data management module 54 determines that the weather data is current, or up-to-date, the data management module 54 may display the weather data on the user interface 38. However, if the data management module 54 determines that the weather data is not current or not up-to-date, the data management module 54 may issue a request to the weather data server network 14 for updated weather data via the network interface module 58. The network interface module 58 may include hardware and software configured to enable the mobile computing device 12 to communicate over a network with the weather data server network 14. The network interface module 58 may be configured to enable the mobile computing device 12 and the weather data server network 14 to transmit and receive information via a cellular network, WiFi network, Internet, or other communications means.

The location of the most recent weather update may be stored in the local weather and locations data cache 56 or some other form of memory as an initial “stored location.” The current location of the mobile computing device 12 may also optionally be stored in the local weather and locations data cache 56 or some other form of memory. In one embodiment, the mobile device application 45 may use the current location to track the movement of the mobile computing device 12, and may also transmit the stored current location to the weather data server network 14. As such, the weather data server network 14 may also optionally track the movement of the mobile device 12. As the mobile computing device 12 updates its calculated geo-location or current location, the mobile computing device 12 may transmit the updated locations to the weather data server network 14. As the geo-location is updated, the mobile device application 45 of the mobile computing device 12 or the weather data server network 14 may determine whether the mobile computing device 12 has moved outside the distance threshold, or a certain predetermined geospatial radius (such as, for example, 3 km), from the previously stored location. In one embodiment, if the mobile computing device 12 has not travelled beyond the radius, weather data generally will not be requested by nor pushed to the mobile computing device 12, unless, for example, special weather conditions warrants a weather alert to be pushed or sent to the mobile computing device 12. In this embodiment, if the mobile computing device 12 has travelled beyond the radius, the mobile device application 45 may automatically request (without user interaction or confirmation) the most up-to-date weather data for the current location from the weather data server network 14 and may store this current location as the “stored location.” The user may optionally set the predetermined radius, which is then stored on the mobile computing device 12 or the radius may be preprogrammed in the mobile computing device 12. It is contemplated that the mobile device client 45 may perform these operations while running in the background. These operations may also be performed by the operating system or firmware on the mobile computing device 12. In embodiments wherein the weather data server network 14 can also track the movement of the mobile computing device 12 by receiving updated geo-locations of the mobile computing device 12, the weather data server 14 may also be configured to detect when the device has travelled beyond a pre-defined radius such that the weather data server network 14 may push the most up-to-date weather data automatically, without receiving a request from the mobile computing device 12. After pushing the weather data, the weather data server network 14 may also optionally store the received geo-location of the mobile computing device 12.

In one embodiment, an elapsed time or proximity to one or more destinations on a pre-defined route may also trigger a weather data request or push such that updated weather data may be displayed via the user interface 38. In embodiments wherein elapsed time is used, the timing module 52 may be configured to transmit time signals to the update request module 50. One or both of the mobile device application 45 or the weather data server network 14 may store the time of the most recent request or push of the weather data. Accordingly, the time of the most recent request or push of the weather update may be referred to as the “stored time.” The update request module 50 may then determine if the predetermined minimum time interval, beyond which weather data is considered “stale” or not up-to-date, has been exceeded by calculating the different between the current time and the “stored time.” The minimum time interval may be set by the user or may be preprogrammed. If the minimum time interval has elapsed, the mobile device application 45 may request updated weather data from the weather data server 14 and store the time of the request as the “stored time,” or the weather data server 14 may push weather data to the mobile computing device 12 and store the time of the push as the “stored time.” The time data may be stored in a memory associated with the timing module 52, the local weather and data cache 56, or other memory.

In one embodiment, weather data may be updated based on both distance travelled and time elapsed. For example, weather data may be updated when the mobile computing device 12 has moved outside the predetermined radius. However, if the mobile computing device 12 stays in the predetermined radius for a predetermined minimum amount of time, then the weather data may be updated at a predetermined time interval. For example, in one embodiment, if the mobile computing device 12 stays in the predetermined radius for at least 5 minutes, the mobile computing device 12 may be triggered to automatically update the weather data when the initial 5 minute interval elapses and every 5 minutes thereafter. The user may optionally set the predetermined radius, the predetermined minimum amount of time, and the time interval for automatic updates, or the aforementioned settings may be preprogrammed. The user may also optionally change the method of updates, such as disabling/enabling the updates based on distance travelled and/or disabling/enabling the updates based on time elapsed. In one embodiment, the user may optionally disable automatic weather data updates such that the mobile computing device 12 will only receive updates when the mobile device application 45 is initially turned on or accessed. In one embodiment, the mobile device application 45 will only submit a weather update request to the web data server network 14 after the user confirms the request. It is contemplated that in some embodiments, the weather data may be updated based only on the threshold time having elapsed. As such, the weather data may be updated at the predetermined minimum time interval, as discussed above,

In one embodiment, the client application or weather data server network may also compare the mobile computing device's 12 current geo-location with pre-defined destinations on a pre-defined route. Based on the proximity to those destinations and/or on motion parameters, such as the velocity of the mobile computing device 12, the most up-to-date weather data for those destinations may be sent to the mobile computing device 12 through a request to or a push by the weather data server network 14. As mentioned above, in one embodiment, signal triangulation and source geo-coding may be used by the mobile computing device 12 to compute the mobile computing device's 12 physical location and motion, such as speed and direction of movement. The geospatial radius, elapsed time, and proximity and motion parameters may be pre-defined or defined by a user. For example, the client application may provide a user interface 38 for setting the threshold values that trigger a weather data request or push. The threshold values may be communicated to the weather data server network 14 via the network interface 58. The pre-defined destinations on a pre-defined route may also be set by the user via the user interface 38. Alternatively, the user may set the predefined destinations on a pre-defined route or other parameters elsewhere, such as, for example, on a personal computer, and the user may then upload the information to the mobile computing device 12.

The alert manager module 60 may be configured to handle weather alerts generated by the weather data server network 14. The alert manager module 60 may receive alerts from the weather data server network 14 via the network interface 58. The alert manager module 60 may then display the alert on the user interface 38 based on the user's preferences. For example, the user may choose the option of displaying alerts only when the user manually chooses alerts to be displayed. Alternatively, the user may choose the option of having alerts be displayed automatically on the user interface 38 when the specific conditions for the alerts to be displayed have been satisfied. In some embodiments, the user may also set the preferred method of receiving alerts. For example, the user may select what kind of alerts will be issued, such as for example, audio, visual, or vibrating, when the conditions for each weather variable has been satisfied. The user may set alert preferences via the user interface 38. The alert preferences may be stored in a memory associated with the alert manager module 60, in the local weather and locations data cache 56, or in other memory.

The user may also use the user interface 38 to select the weather data that the user would like to receive via the mobile computing device 12. In one embodiment, the weather data may include the current weather condition and weather forecasts. The conditions and forecasts may contain, in one embodiment, weather variables such as temperature, wind speed, humidity, barometric pressure, chance of precipitation, or amount of precipitation. This selection may then be transmitted to the weather data server network 14, which may store this selection as the user's favorite variables in the geo-locations and weather variables database 22. The selection may also be optionally stored in the user profile in the user preferences database 26 of the weather data server network 14.

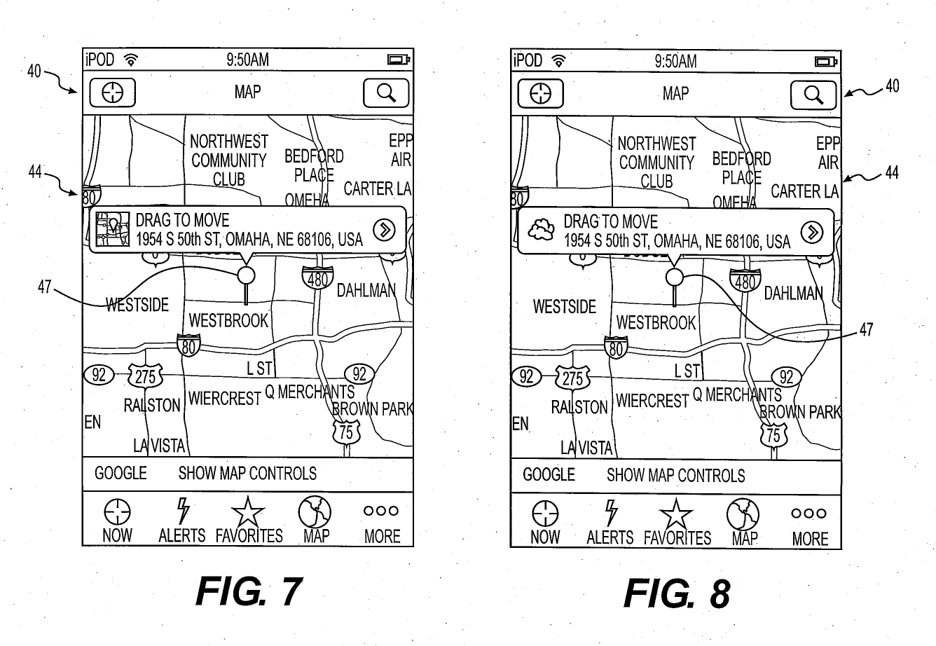

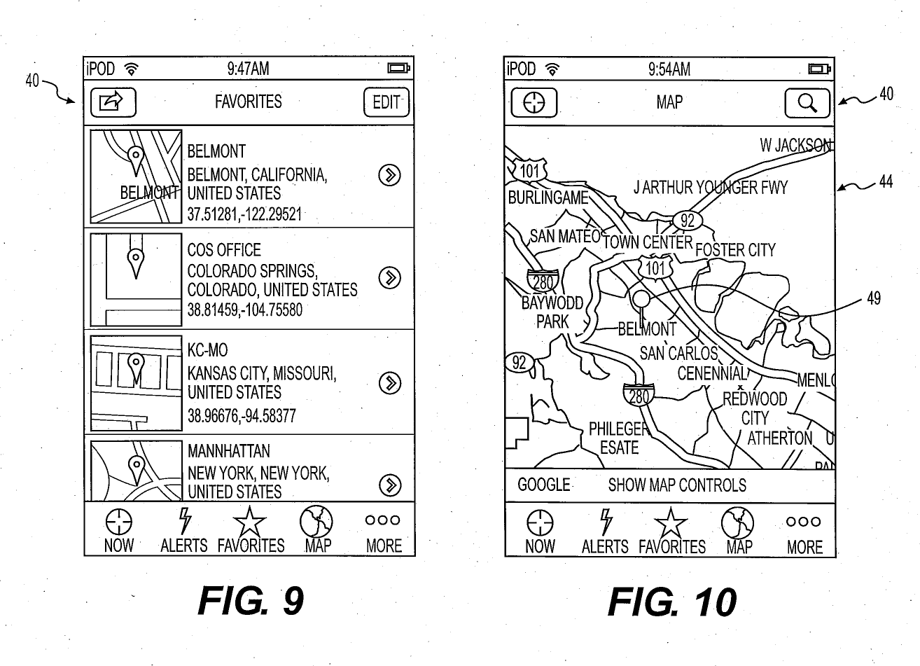

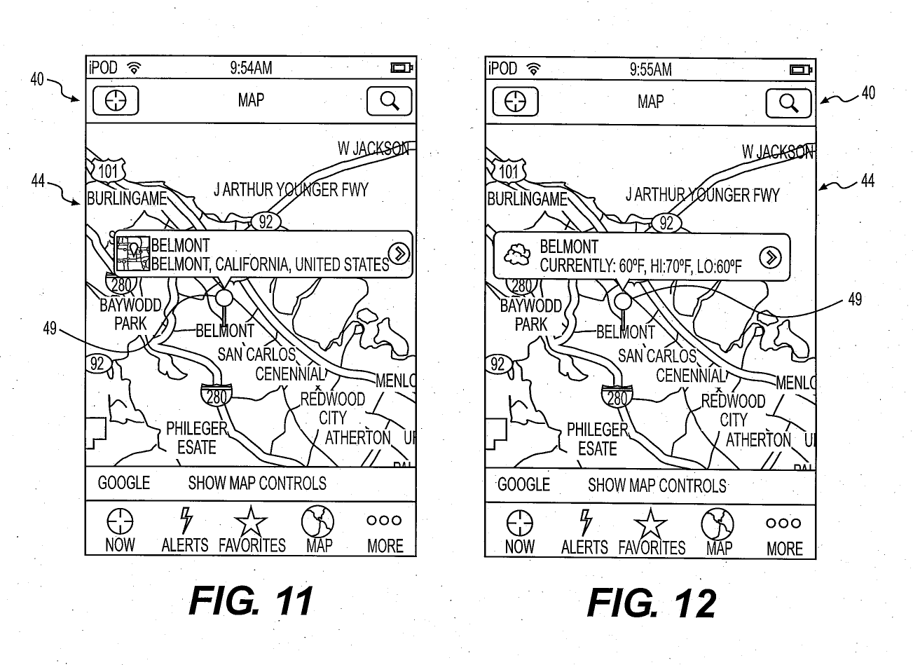

The client interface 38 may also be configured to provide the interactive map 44 that allows the user to select locations for which to receive weather data. For example, the user interface 38 may comprise the touch screen 42. The weather data server network 14 may be configured to deliver either the current weather data or weather variables for the selected location, or may deliver forecasted weather, data for that location. As shown in FIG. 6, the user interface 38 may display a “drop pin” feature wherein a pin 47 (see FIG. 7) may be dropped on the interactive map 44 to the user selected geo-location coordinates. The mobile device application 45 may be configured to process this selected geo-location and request current and forecasted weather data for the selected geo-location coordinates from the weather data server network 14. In one embodiment, the user may also select a favorite location from a list of “favorite locations.” The user may enter addresses into the mobile computing device 12 to be stored as a “favorite location.” The addresses may be associated with, for example, the user's home, the user's office, the user's children's school, and other locations. In one embodiment, addresses may be exported into the mobile computing device 12 to be saved as “favorite locations.” In one embodiment, the user may drop a pin 47 onto the interactive map 44 and save the address of the location of the pin 47 drop as a “favorite location.” The favorite locations and details of the favorite locations, such as the name and address of the location, may be displayed on the user interface 38 (see FIG. 9). The user may optionally enter a favorite description for each favorite location such that the description will be displayed when the favorite location list is displayed. The operation of the interactive map 44 and the pin 47 will be described later.

FIG. 3 shows a method 62 of operating the weather update request module 50, and in particular, implementing the “track-me” feature of this invention. The method 62 starts out in procedure 64 where the user turns on the mobile device application 45. The user may turn on the mobile device application 45 by accessing the mobile device application 45 via the user interface 38. The method 62 proceeds to procedure 66 where the mobile device application 45 obtains the current geo-location of the mobile computing device 12. As described previously, the mobile device application 45 may obtain the current geo-location of the mobile computing device 12 via the location sensing, modules 48a, 48b, 48c. In some embodiments, the location sensing modules 48a, 48b, 48c are associated with GPS receivers or WiFi network (IEEE 802.11x) location sensors, and the geo-location is represented in global latitude and longitude coordinates. After obtaining the current location, the mobile device application 45 may forward the current location to the weather update request module 50. The method 62 then proceeds to procedure 68 where the update request module 50 obtains the current time from the timing module 52. The method 62 then proceeds to procedure 70 where the update request module 50 calculates the elapsed time since the time of the last weather data update, or the “stored time,” for the current location. The method 62 then proceeds to procedure 72 where the update request module 50 determines if the elapsed time is above the predetermined minimum time interval (such as, for example, 15 minutes). If the elapsed time is not above the predetermined minimum time interval, the method 62 proceeds to procedure 74 where the mobile device application 45 may perform a straight-line distance calculation from the current location, or the current location obtained by the location manager module 46, to the “stored location.” The method 62 proceeds to procedure 76 where the mobile device application 45 determines if the distance between the current location and the “stored location” exceeds the predetermined radius (beyond which weather updates are automatically requested). If the distance between the current location and the “stored location” does not exceed the predetermined radius, then the method 62 proceeds back to procedure 66 where the mobile device application 45 obtains the current location of the mobile computing device 12.

Referring back to procedure 70, if there is no “stored time,” then the method 62 proceeds to procedure 78 where the update request module 50 requests a weather update from the weather data server network 14 based on the current location. The method then proceeds to procedure 80 where the current time and current location, which are also the time and location of the aforementioned update, is stored as the “stored time” and “stored location”, respectively, in the mobile computing device 12.

Referring back to procedure 72, if the elapsed time is above the predetermined minimum time interval, then the method 62 proceeds to procedure 78 where the update request module 50 requests a weather update from the weather data server network 14 based on the current location. Thus, the predetermined minimum time interval enables up-to-date weather data to be provided to the mobile computing device 12 regardless of the movement (or lack thereof) of the mobile computing device 12. The method then proceeds to procedure 80 where the current time and current location is stored as the “stored time” and “stored location”, respectively, in the mobile computing device 12.

Referring back to procedure 76, if the distance between the current location and the “stored location” exceeds the predetermined radius (such as, for example, 3 km in one embodiment), the method 62 proceeds to procedure 78 where the update request module 50 automatically sends a weather data request to the weather data server network 14 for the weather data based on the current location. The method then proceeds to procedure 80 where the current time and current location is stored as the “stored time” and “stored location”, respectively, in the mobile computing device 12.

After the weather data has been requested in procedure 78, the method 62 proceeds to procedure 82 where the updated weather data is sent from the weather data server network 14 to the mobile device application 45. The method 62 then proceeds to procedure 84 where the updated weather data is displayed on the user interface 38. The method 62 then proceeds to procedure 86 where the updated weather data, stored location, and stored time are stored in the local weather and locations data cache 56. The method 62 may be repeated at regular intervals to continuously monitor the current location of the mobile computing device 12 and to track the mobile computing device 12 so that the up-to-date weather data for the current location may be provided to the mobile computing device 12.

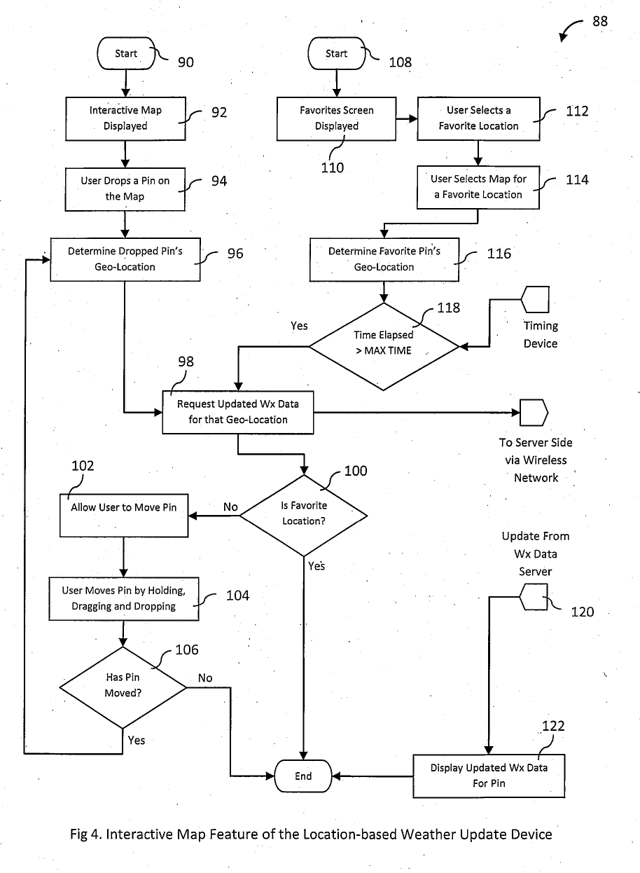

FIG. 4 shows a method 88 of operating the weather update system 10, and in particular, the user interface 38 of the mobile computing device 12. The method 88 starts at procedure 90 where the mobile device application 45 is turned on, such as by accessing the mobile device application 45 via the user interface 38. The method 88 proceeds to procedure 92 where the interactive map 44 is displayed on the user interface 38. The method 88 then proceeds to procedure 94 where the user selects the “drop pin” feature via the touch screen 42, and a pin 47 is “dropped” onto the interactive map 44 as a result. In some embodiments, the user may use a different input device that is configured to interact with the user interface 38. In one embodiment, the pin 47 is initially dropped onto the center of interactive map 44. After the pin 47 has been dropped at a location, the method 88 proceeds to procedure 96 where the mobile device application 45 obtains/calculates the dropped pin's latitude and longitude location coordinates. The method 88 then proceeds to procedure 98 where the mobile device application 45 requests weather data for that location from the weather data server network 14. The user may choose to have the weather data be displayed on the user interface 38. The method 88 then proceeds to procedure 100 where the mobile device application 45 determines whether the location of the pin 47 is a “favorite location.” In one embodiment, if the location of the pin 47 is a “favorite location,” the weather data may be displayed on the user interface 38 and the method 88 may end. If the location of the pin 47 is not a “favorite location,” the method 88 proceeds to procedure 102 where the mobile computing device 12 enables the user to move the location of the pin 47. If the user moves the pin 47 to another location, the method 88 proceeds to procedure 104. The user may move the pin 47 by holding, dragging, and dropping the pin 47 at a new location via the touch screen 42 or other input devices. The method 88 then proceeds to procedure 106 where the mobile device application 45 determines if the pin has been re-located. If so, the method 88 returns to procedure 96 where the mobile device application 45 determines the latitude and longitude coordinates of the pin 47. The method 88 then proceeds to procedure 98 as described above so that the weather data may be updated according to the new location. After the updated weather data has been received from the weather data server network 14, the weather data may be displayed on the user interface 38. In one embodiment, links for automatically accessing other windows (so-called “pop-up windows”) are embedded therein. In one embodiment, the weather data may be displayed in a pop-up window over the interactive map 44. In one embodiment, the display 40 may alternate between the weather data and information associated with the location of the pin 47. In one embodiment, the display 40 may alternate every 1 to 5 seconds, depending on the user's preference or a preprogrammed setting.

The method 88 may also start at procedure 108 where the mobile device application 45 is turned on, such as by accessing the mobile device application 45 via the user interface 38. The method 88 then proceeds to procedure 110 where the user interface displays a list or information associated with the favorite locations of the user (see FIG. 9). The method 88 proceeds to procedure 112 where the user selects a favorite location from the list of “favorite locations.” In procedure 114, the user may select the option of displaying the favorite location on the interactive map 44. In one embodiment, the selected favorite location may identified by a favorite pin 49 on the interactive map 44. The favorite pin 49 may be of a different color or shape from the pin 47 described above. It is contemplated that pins 47, 49 may take other forms, such as, for example, stars, circles, or other means of identifying locations. The method 88 then proceeds to procedure 116 where the mobile computing device 12 determines the geo-location (latitude and longitude) of the pin 49. After obtaining the geo-location of the pin 49, the mobile device application 45 may request updated weather data from the weather data server network 14. The user may select the pin 49 by touching it via the touch screen 42 or may select it using other input devices. As a result, the user interface 38 may display information associated with the location of the pin 49, such as the address or other descriptions. In one embodiment, the user may set the types of description to be displayed. In one embodiment, the user interface 38 may alternate between displaying the information associated with the location of the pin 49 and weather data for the location of the pin 49. In one embodiment, the user cannot move the favorite pin 49 on the interactive map 44, in contrast to the location pin 47.

The method 88 may proceed to procedure 118 where the mobile computing device 12 determines whether a certain period of time has elapsed since the pin 49 has been displayed and there has not been any manually triggered updates of the weather data. The time information may be provided by the timing module 52 of the mobile device application 45. In one embodiment, the aforementioned certain period of time may be 15 minutes. If the aforementioned certain period of time has elapsed, the method 88 proceeds to procedure 98, as described above, where the mobile device application 45 requests updated weather data from weather data server network 14 for the location of the favorite pin 49.

When updated weather data is requested, weather data may be provided by the weather data server network 14 in procedure 120. The method 88 proceeds to procedure 122 wherein the weather data is displayed via the user interface 38. It is contemplated that any combination of the components of the weather update system 10 may be used to perform the methods 62, 88 described above. Software, firmware, and hardware may be used to perform the methods 62, 88.

Embodiments of the invention may be made in hardware, firmware, software, or various combinations thereof. The invention may also be implemented as instructions stored on a machine-readable medium, which may be read and executed using one or more processing devices. In one embodiment, the machine-readable medium may include various mechanisms for storing and/or transmitting information in a form that can be read by a machine (e.g., a computing device). For example, a machine-readable storage medium may include read only memory, random access memory, magnetic disk storage media, optical storage media, flash memory devices, and other media for storing information, and a machine-readable transmission media may include forms of propagated signals, including carrier waves, infrared signals, digital signals, and other media for transmitting information. While firmware, software, routines, or instructions may be described in the above disclosure in terms of specific exemplary aspects and embodiments performing certain actions, it will be apparent that such descriptions are merely for the sake of convenience and that such actions in fact result from computing devices, processing devices, processors, controllers, or other devices or machines executing the firmware, software, routines, or instructions.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment. Furthermore, since numerous modifications and changes will readily occur to those of skill in the art, it is not desired to limit the invention to the exact construction and operation described herein. Accordingly, all suitable modifications and equivalents should be considered as falling within the spirit and scope of the invention.

What is claimed is:

1. A mobile computing device for updating weather data, the mobile computing device including a processor and a location data receiver capable of establishing a geospatial location of the mobile computing device based on received data signals, and wherein said mobile computing device is configured to receive updated weather data in response to a threshold condition having been met.

2. The mobile computing device according to claim 1, wherein the mobile computing device is further configured to determine when the threshold condition has been met, and wherein the mobile computing device is configured to submit a weather data request for the geospatial location of the mobile computing device in response to the threshold condition having been met.

3. The mobile computing device of claim 1, further comprising a timer configured to measure elapsed time.

4. The mobile computing device of claim 1, wherein the threshold condition comprises a threshold distance having been traveled by the mobile computing device.

5. The mobile computing device of claim 3, wherein the threshold condition comprises a threshold time having elapsed.

6. The mobile computing device according to claim 1, wherein the location data receiver comprises a GPS receiver, and wherein the data signals comprise GPS satellite signals.

7. The mobile computing device according to claim 1, wherein the location data receiver comprises a WiFi receiver embedded in said mobile computing device, and wherein the mobile computing device calculates the geospatial location'based on WiFi network signals and a geospatial-coded WiFi signal source map.

8. The mobile computing device according to claim 1, wherein the location data receiver comprises a cellular receiver embedded in said mobile computing device, and wherein the mobile computing device calculates the geospatial location based on cellular network signals and a geospatial-coded cellular signal source map.

9. The mobile computing device according to claim 4, wherein said threshold distance is 3 km or less.

10. The mobile computing device according to claim 1, wherein the mobile computing device is configured to receive updated weather data further based on the distance from the geospatial location of the mobile computing device to one or more geospatial locations along a predefined route.

11. The mobile computing device according to claim 1, wherein the mobile computing device is configured to receive updated weather data further based on the speed and direction of travel of the mobile computing device.

12. A mobile computing device for updating weather data, comprising:
a housing;
a location data receiver within the housing;
a processor within the housing; and
a user interface, said user interface allowing users to input a location on an interactive map, wherein said mobile computing device submits a request for weather data based on said inputted geospatial location.

13. The mobile computing device according to claim 12, further comprising a timer configured to measure elapsed time.

14. The mobile computing device according to claim 12, wherein the request for weather data comprises an automatic request.

15. The mobile computing device according to claim 12, wherein said user interface is configured to allow users to select data variables to be updated from a list of data variables available to a data server network.

16. The mobile computing device according to claim 12, wherein said data variables from said list comprise current or forecasted weather data variables, including one or more of temperature, wind speed, humidity, barometric pressure, amount of precipitation, or chance of precipitation.

17. The mobile computing device according to claim 12, wherein said user interface comprises a touch screen.

18. A system for updating weather data, comprising:
a weather data server network configured to receive current and forecasted weather data for a plurality of locations and times,
wherein said weather data server network is configured to transmit weather data for a geospatial location of a mobile computing device in response to a threshold condition having been met.

19. The system of claim 18, wherein the threshold condition comprises a threshold distance having been traveled by the mobile computing device.

20. The system of claim 18, wherein the threshold condition comprises a threshold time having elapsed.

21. The system according to claim 18, wherein said weather data server network is further configured to receive a weather data request for weather data at a geospatial location from a mobile computing device, and respond to said weather data request with weather data for said geospatial location.

22. The system according to claim 18, wherein the mobile computing device is further configured to track the distance traveled by the mobile computing device.

23. The system according to claim 18, wherein said current and forecasted weather data received by said weather data server network corresponds to current and forecasted weather for a grid of locations

24. The system according to claim 23, wherein the distance between adjacent points on the grid being 1 km or less.

25. The system according to claim 18, wherein said weather data server network is configured to transmit a weather alert to a mobile computing device based on forecasted weather data.

26. The system according to claim 18, wherein said weather data server network is further configured to store a user profile, said profile comprising a collection of one or more favorite data to be transmitted to a mobile computing device associated with said profile; and wherein said weather data server network is configured to automatically transmit one or more favorite data in said collection to said mobile computing device.

27. The system for updating weather data of claim 26, wherein said collection comprises weather data for one or more favorite locations.

28. A method for updating weather data, comprising:
determining on a mobile computing device the geospatial location of said mobile computing device based on received data signals;
receiving updated weather data in response to a threshold condition having been met.

29. The method for updating weather data according to claim 28, wherein receiving updated weather data further comprises:
determining on the mobile computing device whether the threshold condition has been met; and
submitting a weather data request for the geospatial location of the mobile computing device in response to the threshold condition having been met.

30. The method of claim 28, wherein the threshold condition comprises a threshold distance having been traveled by the mobile computing device.

31. The method of claim 28, wherein the threshold condition comprises a threshold time having elapsed.

32. The method for updating weather data according to claim 28, wherein determining the geospatial location of the mobile computing device comprises using GPS satellite signals.

33. The method for updating weather data according to claim 28, wherein determining the geospatial location of the mobile computing device comprises using WiFi network signals and a geospatial-coded WiFi signal source map.

34. The method for updating weather data according to claim 28, wherein determining the geospatial location of the mobile computing device comprises using cellular signals and a geospatial-coded cellular signal source map.

35. The method for updating weather data according to claim 30, wherein said threshold distance is 3 km or less.

36. The method for updating weather data according to claim 28, wherein receiving updated weather data is further based on the distance from the geospatial location of the mobile computing device to one or more geospatial locations along a predefined route.

37. The method for updating weather data according to claim 28, wherein receiving updated weather data is further based on the speed and direction of travel of the mobile computing device.

38. A method for updating weather data, comprising:
presenting on a mobile computing device a user interface having an interactive map, said interface allowing users to input a location on said interactive map; and
submitting a request for weather data based on the inputted location.

39. The method for updating weather data according to claim 38, wherein the request for weather data comprises an automatic request.

40. The method for updating weather data according to claim 38, wherein submitting a request for weather data comprises submitting an automatic request for weather data.

41. The method for updating weather data according to claim 38, wherein said user interface allows users to select data variables to be updated from a list of data variables available to a data server network;

42. The method for updating weather data according to claim 41, wherein said data variables from said list comprise current or forecasted weather data variables, including one or more of temperature, wind speed, humidity, barometric pressure, amount of precipitation, or chance of precipitation.

43. The method for updating weather data according to claim 38, wherein presenting a user interface further comprises presenting the user interface on a touch screen.

44. A method for updating weather data, comprising:
receiving at a data server network current and forecasted weather data for a plurality of locations and times;
transmitting weather data for the geospatial location of a mobile computing device in response to a threshold condition having been met.

45. The method of claim 44, wherein the threshold condition comprises a threshold distance having been traveled by the mobile computing device.

46. The method of claim 44, wherein the threshold condition comprises a threshold time having elapsed.

47. The method for updating weather data according to claim 44, wherein transmitting weather data further comprises:
receiving from a mobile computing device a request for weather data at a geospatial location; and
responding to said mobile computing device with weather data for the geospatial location.

48. The method for updating weather data according to claim 44, wherein transmitting weather data further comprises tracking at the data server network the distance traveled by the mobile computing device.

49. The method for updating weather data according to claim 44, wherein said received current and forecasted weather data correspond to current and forecasted weather data for a grid of locations.

50. The method according to claim 49, wherein the distance between adjacent points on the grid is 1 km or less.

51. The method for updating weather data according to claim 44, further comprising:
storing a user profile, said profile comprising a collection of one or more favorite data to be transmitted to a mobile computing device associated with said profile; and
automatically transmitting one or more favorite data in said collection to said mobile computing device.

52. The method for updating weather data according to claim 51, wherein said collection comprises weather data for one or more favorite locations.

53. The method for updating weather data according to claim 44, further comprising determining whether to transmit a weather alert to the mobile computing device based on forecasted weather data, and locations of interest.

54. A system for weather data delivery, comprising:
a weather data server network arranged to receive weather data;
a mobile computing device comprising a location data receiver and a processor, the mobile computing device capable of receiving geospatial data and establishing its geospatial location based on the data;
wherein the weather data server network transmits updated weather data for the geospatial location of the mobile computing device in response to a threshold condition having been met.

55. The system of claim 54, wherein the threshold condition comprises a threshold distance having been traveled by the mobile computing device.

56. The system of claim 54, wherein the threshold condition comprises a threshold time having elapsed.

57. The system according to claim 54, wherein the weather data server network is configured to transmit said updated weather data further in response to a weather data request from the mobile computing device, said weather data request triggered by the threshold condition having been met.

58. A method for weather data delivery, comprising:
receiving, at a weather data server network, weather data;
determining the geospatial location of a mobile computing device based on geospatial data received by a location data receiver on the mobile computing device;
transmitting from the weather data server network to the mobile computing device updated weather data for the geospatial location of the mobile computing device in response to a threshold condition having been met.

59. The method of claim 58, wherein the threshold condition comprises a threshold distance having been traveled by the mobile computing device.

60. The method claim 58, wherein the threshold condition comprises a threshold time having elapsed.

61. The method of claim 58, wherein transmitting said updated weather data is further in response to a weather data request from the mobile computing device, said weather data request triggered by the threshold condition having been met.

62. A computer-readable medium having computer-executable instructions for execution by a processing system, the computer-executable instructions for receiving weather data by a mobile computing device, the computer-readable medium comprising instructions for:
determining a geospatial location of the mobile computing device based on received data signals; and
receiving updated weather data in response to a threshold condition having been met.

63. The computer-readable medium of claim 62, further comprising instructions for:
determining whether the threshold condition having been met; and
submitting a weather data request for the geospatial location of the mobile computing device in response to the threshold condition having been met.

64. The computer-readable medium of claim 62, wherein the threshold condition comprises a threshold distance having been traveled by the mobile computing device.

65. The m computer-readable medium of claim 62, wherein the threshold condition comprises a threshold time having elapsed.

66. A computer-readable medium having computer-executable instructions for execution by a processing system, the computer-executable instructions for providing weather data by a weather data server network, the computer-readable medium comprising instructions for:
receiving current and forecasted weather data for a plurality of locations and times;
determining a geospatial location of a mobile computing device based on geospatial data received from the mobile computing device; and
transmitting weather data for the geospatial location of a mobile computing device in response to a threshold condition having been met.

67. The computer-readable medium of claim 66, wherein the threshold condition comprises a threshold distance having been traveled by the mobile computing device.

68. The computer-readable medium of claim 66, wherein the'threshold condition comprises a threshold time having elapsed.

69. The computer-readable medium of claim 66, further comprising instructions for:
determining whether to transmit a weather alert to the mobile computing device based on forecasted weather data.

70. The computer-readable medium of claim 66, wherein the current and forecasted weather data corresponds to current and forecasted weather data for a grid of locations.

71. The computer-readable medium of claim 70, wherein the distance between adjacent points on the grid is 1 km or less.
